(19) United States
(12) Patent Application Publication
(10) Pub. No.: US 2026/0117832 A1
(43) Pub. Date: Apr. 30, 2026

(54) VEHICLE BRAKE SYSTEM AND BRAKE ASSEMBLY

(71) Applicant: ZF Active Safety GmbH, Koblenz (DE)

(72) Inventor: Volker Knop, Ulmen (DE)

(73) Assignee: ZF Active Safety GmbH, Koblenz (DE)

(21) Appl. No.: 19/063,162

(22) Filed: Feb. 25, 2025

(30) Foreign Application Priority Data
Mar. 5, 2024 (DE) 102024106308.4

(51) Int. Cl. F16D 65/18; F16D 55/226; F16D 121/24

(52) U.S. Cl. CPC F16D 65/18; F16D 55/226; F16D 2121/24

(57) ABSTRACT

The disclosure relates to a vehicle brake system having a vehicle axle and a first and second brake assembly for a respective electromechanical vehicle brake. The brake assemblies can be arranged on opposite sides of the vehicle axle at the same position relative to the brake rotor provided there, wherein the first brake assembly has an actuator assembly fastened to the brake calliper in the first position and the second brake assembly has an actuator assembly fastened to the brake calliper in the second position, and the brake callipers and the actuator assemblies can be positioned with mirror symmetry relative to a vertical mirror plane extending along the central longitudinal axis of the vehicle. The disclosure also relates to a brake assembly.

### CROSS-REFERENCE TO RELATED APPLICATIONS

This application claims priority to German Patent Application No. 102024106308.4, filed Mar. 5, 2024, the disclosure of which is incorporated herein by reference in its entirety.

### TECHNICAL FIELD

The disclosure relates to a vehicle brake system having a vehicle axle and a first and second brake assembly for a respective electromechanical vehicle brake.

In addition, the disclosure also relates to a brake assembly for an electromechanical vehicle brake.

### BACKGROUND

Brake assemblies usually have a brake calliper and a brake piston which is guided linearly in the brake calliper and can be moved between a first, extended position and a second, retracted position in order to apply a brake pad to a brake rotor. For this purpose, such a brake assembly usually has an actuator assembly comprising an electric motor, which is coupled to the brake piston via a gear unit and a spindle drive so as to be drivable.

The brake assemblies associated with the left and right side of a vehicle axle are usually designed differently, as the alignment of the actuator assemblies on the brake calliper differs depending on the side of the vehicle. For exmaple, the brake callipers and actuator assemblies differ depending on the side of the vehicle. This is disadvantageous in terms of manufacturing costs, as a separate die has to be produced for each different component. A large variety of components also increases the logistical effort.

What is needed is therefore to provide a vehicle brake system having an increased number of identical parts, and a brake assembly with which a high number of identical parts can be achieved in a vehicle brake system.

### SUMMARY

A vehicle brake system is proposed herein, having a vehicle axle and a first and second brake assembly for a respective electromechanical vehicle brake. The brake assemblies each have a brake calliper in which a space is provided for accommodating a brake rotor, a linearly guided brake piston that can be moved between a first, extended position and a second, retracted position in order to apply a brake pad to the brake rotor, and an actuator assembly that can be fastened to the associated brake calliper. The brake callipers, brake pistons and actuator assemblies are each identical in their respective construction. A fastening geometry for fastening the actuator assembly is provided on the brake callipers, which fastening geometry is designed in such a way that the actuator assembly can be mounted on the brake calliper in a first position and a second position relative to said brake calliper, and the brake assemblies can be arranged on opposite sides of the vehicle axle at the same position relative to the brake rotor provided there, wherein the first brake assembly has an actuator assembly fastened to the brake calliper in the first position and the second brake assembly has an actuator assembly fastened to the brake calliper in the second position, and the brake callipers and the actuator assemblies can be positioned with mirror symmetry relative to a vertical mirror plane extending along the central longitudinal axis of the vehicle.

As the brake callipers, brake pistons and actuator assemblies are identical in their respective construction, the variety of components in the vehicle brake system is significantly reduced, making the vehicle brake system particularly cost-effective to manufacture. For example, owing to the large number of identical components, die costs are reduced.

The option of mounting the actuator assembly on the brake calliper in a first and a second position means that the arrangement of the actuator assemblies can be adapted to the installation space conditions on the opposite sides of the vehicle axle.

The mirror-symmetrical arrangement is particularly advantageous in terms of load distribution on the vehicle axle.

A brake assembly is also proposed herein, for example for an electromechanical vehicle brake of a vehicle brake system according to the disclosure, having a brake calliper designed as a floating calliper with two guide pins forming a linear bearing, in which brake calliper a space is provided for accommodating a brake rotor, a linearly guided brake piston that can be moved between a first, extended position and a second, retracted position in order to apply a brake pad to the brake rotor, and an actuator assembly that can be fastened to the brake calliper. A fastening geometry is provided on the brake calliper for fastening the actuator assembly, which fastening geometry is designed such that the actuator assembly can be mounted on the brake calliper in a first position and a second position relative to said brake calliper, such that the actuator assembly, viewed in the direction of the guide pins, can be mounted relative to a connecting line of the centres of the two guide pins in angular positions that are equal in magnitude but opposite in direction.

Such a brake assembly can be mounted on opposite sides of a vehicle axle, specifically in such a way that the brake assembly is mirror-symmetrical to a vertical mirror plane extending along the central longitudinal axis of the vehicle. As already disclosed in connection with the vehicle brake system, this reduces the variety of components.

The fastening geometry may comprise first and second fastening elements, which in relation to the connecting line of the centres of the two guide pins are in angular positions that are equal in magnitude but opposite in direction. In this way, the actuator assembly can be fastened to the brake calliper in such different angular positions that, in the case of a brake assembly fastened to a first side of the vehicle axle with an actuator assembly arranged in the first angular position and in the case of a brake assembly fastened to the second side of the vehicle axle opposite the first side with an actuator assembly arranged in the second angular position, the actuator assemblies in the vehicle are oriented in the same direction.

According to one exemplary arrangement, the first and second fastening elements each have a pair of fastening points lying on a common arc of a circle around a central axis of the brake piston. This ensures that the actuator assembly can be coupled equally with the brake piston in any orientation in order to drive the latter.

A connecting line of the fastening points of the first fastening element and a connecting line of the fastening points of the second fastening element enclose, for example, an angle of equal magnitude with the connecting line of the centres of the two guide pins.

For example, the fastening geometry comprises at least four fastening points, which, viewed in the direction of the guide pins, lie diametrically to the central axis of the brake piston. This allows the actuator assembly to be mounted in at least four different positions on the brake calliper. This makes it conceivable that even in a vehicle brake system in which a brake assembly is arranged on opposite sides of the front axle and on the opposite sides of the rear axle, a brake assembly with identical brake callipers, brake pistons and actuator assemblies is arranged at each position, with the actuator assemblies on the brake callipers each being arranged in a different position. In this way, for example, the variety of components can be significantly reduced in a vehicle brake system designed as an all-wheel brake.

For example, the brake calliper is designed to be plane-symmetrical with respect to a plane of symmetry, which, on one side, extends in the direction of the guide pins and, on the other side, viewed in the direction of the guide pins, extends perpendicularly relative to the connecting line of the centres of the two guide pins and also along the guide pins. In one exemplary arrangement, a connecting line of the centres of the guide pins forms the normal of the plane of symmetry. This means that if the brake calliper is arranged on opposite sides of the vehicle axle, a brake assembly can be designed symmetrically to a plane extending in the longitudinal and vertical direction of the vehicle.

According to one exemplary arrangement, the fastening elements are positioned relative to one another in such a way that the brake assembly, viewed in the direction of the guide pins, together with the actuator assembly mounted in a first position and a second position, can be arranged mirror-inverted relative to one another with respect to a fictitious mirror plane, for example with respect to the plane extending in the longitudinal direction and vertical direction of the vehicle, in order to form identical brake assemblies for a left wheel and a right wheel. The two brake assemblies can therefore be made up of identical components.

For example, the brake assembly has an electric motor, which is coupled to the brake piston via a gear unit, a drive shaft and a spindle connected to the latter. The gear unit can be used to transmit a rotation of the electric motor to the spindle, the rotation of which is in turn translated into an axial movement of the brake piston. The brake piston can therefore be easily moved between the retracted position and the extended position by control of the electric motor.

The actuator assembly can have an axially extending central plane of symmetry and halves mirrored thereon. This allows the actuator assembly to be fastened mirror-symmetrically to brake assemblies arranged on opposite sides of a vehicle axle.

According to one one exemplary arrangement, the actuator assembly has a housing, on which exactly two fastening points are provided for fastening the actuator assembly to the fastening geometry of the brake calliper. The fastening points are formed by screw lugs, for example. Two fastening points provide stable support for the actuator assembly on the brake calliper.

The housing accommodates, for example, a printed circuit board and/or a gear unit and/or an electric motor for moving the brake piston. For example, it is possible to pre-assemble the respective components in the housing such that the components accommodated in the housing can be handled together with the housing as a unit during assembly, which simplifies assembly.

A plug connector may be arranged on the housing, the plane of symmetry of the actuator assembly extending through the centre of the plug connector. This makes it easy to connect a plug to the actuator assembly in any orientation of the actuator assembly.

In one exemplary arrangement, the brake assembly defines a service brake. This means that the brake piston is actuated during normal service braking and not only during parking braking or, exceptionally, as a parking brake in an emergency. Consequently, the brake piston makes a significant contribution to controlling the driving dynamics.

### BRIEF DESCRIPTION OF THE DRAWINGS

Further advantages and features of the disclosure are shown in the following description and the corresponding drawings, to which reference is made. In the drawings:

FIG. 1 partly schematically shows a vehicle brake system according to an exemplary arrangement of the disclosure with two brake assemblies according to the disclosure,

FIG. 2 shows a brake assembly according to the disclosure from FIG. 1,

FIG. 3 shows a sectional representation of a brake assembly from FIG. 1,

FIG. 4 shows a brake assembly from FIG. 1 with the actuator assembly detached from the brake calliper,

FIG. 5 shows the actuator assembly of a brake assembly from FIG. 1, and

FIG. 6 shows two brake assemblies with differently oriented actuator assemblies.

### DETAILED DESCRIPTION

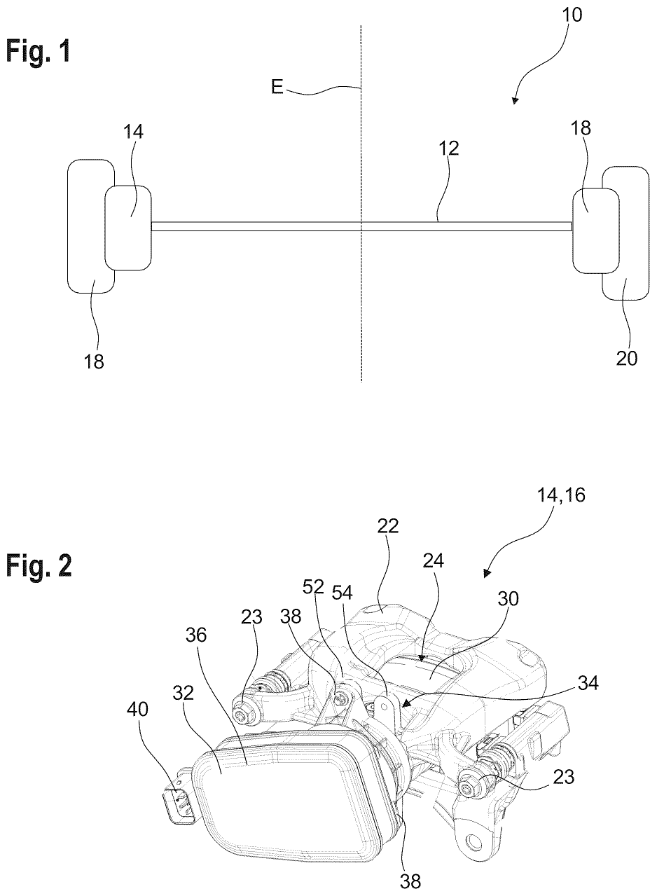

FIG. 1 partly schematically shows a vehicle brake system 10 having a vehicle axle 12, a first brake assembly 14 and a second brake assembly 16 for a respective electromechanical vehicle brake. The brake assemblies 14, 16 each define a service brake.

The brake assemblies 14, 16 are associated with opposite sides of the vehicle axle 12, for example with the vehicle wheels 18, 20 arranged on the opposite sides of the vehicle axle 12.

The construction of the brake assemblies 14, 16 is described in detail in the following.

FIG. 2 shows one of the two brake assemblies 14, 16.

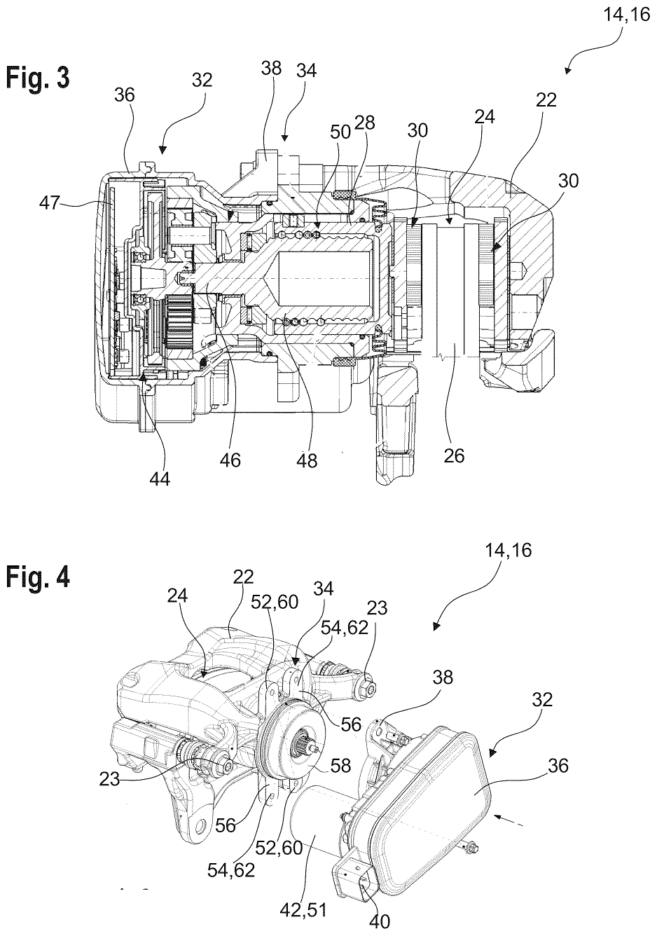

Each brake assembly 14, 16 comprises a brake calliper 22 in which a space 24 is provided for receiving a brake rotor 26 (see FIG. 3). An outline of the brake rotor 26 is also illustrated in FIG. 6.

In one exemplary arrangement, the brake calliper 22 is designed as a floating calliper having two guide pins 23 forming a linear bearing.

Furthermore, each brake assembly 14, 16 comprises a linearly guided brake piston 28 (see FIG. 3) that can be moved between a first, extended position and a second, retracted position in order to apply a brake pad 30 to the brake rotor 26.

In addition, each brake assembly 14, 16 has an actuator assembly 32 that can be fastened to the brake calliper 22.

For this purpose, a fastening geometry 34 is provided on the brake calliper 22 for fastening the actuator group 32. The fastening geometry 34 is designed such that the actuator assembly 32 can be mounted on the brake calliper 22 in a first position and a second position relative to said brake calliper, which will be described in more detail in the following.

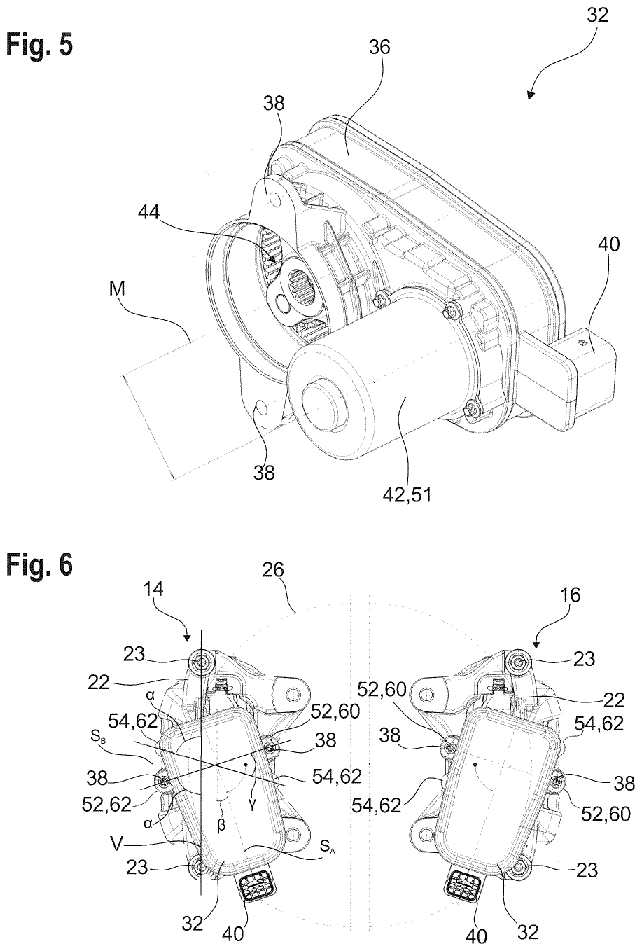

The actuator assembly 32 has a housing 36, on which exactly two fastening points 38 are provided for fastening the actuator group 32 to the fastening geometry 34 of the brake calliper 22, as can be seen in FIGS. 5 and 6, for example. In the exemplary arrangement shown, the fastening points 38 are screw lugs.

In addition, a plug connector 40 for establishing electrical contact with the actuator assembly 32 is arranged on the housing 36.

The actuator assembly 32 has an axially extending central plane of symmetry S_{A} (see FIG. 6) and halves mirrored thereon. The plane of symmetry S extends centrally through the plug connector 40.

The brake calliper 22 is also designed to be plane-symmetrical with respect to a plane of symmetry S_{B} (see FIG. 6), which, on one side, extends in the direction of the guide pins 23 and, on the other side, viewed in the direction of the guide pins 23, extends perpendicularly relative to a connecting line V of the centres of the two guide pins 23 and also along the guide pins 23. For example, the connecting line V is the normal of the plane of symmetry S_{B}.

In addition, the brake assemblies 14, 16 each have an electric motor 42, which is coupled to the brake piston 28 via a gear unit 44, a drive shaft 46 and a spindle 48 connected to the latter.

The gear unit 44 and the spindle 48 can be seen in FIG. 3 and partially in FIGS. 4 and 5.

The spindle 48 is part of a backlash drive 50, which in the exemplary arrangement is a ball screw drive.

In the exemplary arrangement, the gear unit 44 comprises a planetary gear.

The drive shaft 46 is formed in one piece with the spindle 48 in the exemplary arrangement.

A rotation of the spindle 48 caused by the electric motor 42 results in an axial movement of the brake piston 28.

The electric motor 42 and the gear unit 44 as well as a printed circuit board 47, which contains the electronic control unit for controlling the electric motor 42, are accommodated together in the housing 36.

A wall of a receiving space 51, in which the electric motor 42 is accommodated, can be seen in FIGS. 4 and 5.

The brake assemblies 14, 16 are designed in such a way that each of the two brake assemblies 14, 16 can be arranged on an opposite side of the vehicle axle 12 at the same position relative to the brake rotor 26 provided there.

This means that the two brake assemblies 14, 16 shown in FIG. 1 are mutually interchangeable in the construction of the vehicle brake system 10 shown in FIG. 1.

This is achieved firstly by the fact that the brake callipers 22, brake pistons 28 and actuator assemblies 32 are each identical in their respective construction.

The first brake assembly 14 has an actuator assembly 32 fastened to the brake calliper 22 in the first position, and the second brake assembly 16 has an actuator assembly fastened to the brake calliper 22 in the second position. The two brake assemblies 14, 16 with actuator assemblies 32 fastened in different positions are shown in FIG. 6.

In order to be able to fasten the actuator assembly 32 in corresponding positions on the brake calliper 22, the fastening geometry 34 in the exemplary arrangement has first fastening elements 52 and second fastening elements 54 (see FIGS. 2 and 4).

The fastening elements 52, 54 are formed by elongated webs 56, which project from a centring shoulder 58, formed on the brake calliper 22, for the housing 36. In each case, two offset webs 56 form a fastening element 52, 54. The webs 56 and the centring shoulder 58 can be seen in FIG. 4.

The fastening elements 52, 54 in relation to the connecting line V of the centres of the two guide pins 23 are in angular positions that are equal in magnitude but opposite in direction (see FIG. 6). For example, the fastening elements 52, 54 enclose an angle α with the connecting line V.

Thus, the actuator assembly 32, viewed in the direction of the guide pins 23, can be mounted relative to the connecting line V in angular positions that are equal in magnitude but opposite in direction, as can be seen in FIG. 6. In the two brake assemblies 14, 16 shown in FIG. 6, the actuator assembly 32 is mounted in different angular positions accordingly.

The first fastening elements 52 and the second fastening elements 54 each have a pair of fastening points 60, 62. This means that the fastening geometry has a total of four fastening points 60, 62.

In the exemplary arrangement, the fastening points 60, 62 are formed by screw lugs.

The fastening points 60, 62 lie on a common arc of a circle around the central axis M of the brake piston 28. The central axis M of the brake piston 28 is shown in FIG. 5.

Specifically, the fastening points 60, 62, viewed in the direction of the guide pins 23, lie diametrically to the central axis M of the brake piston 28.

The complementary angle β of the angle between the plane of symmetry S_{A} of the actuator assembly 32 and the plane of symmetry S_{B} of the brake calliper 22 is half as large as the pitch angle γ between the connecting lines of the diametrically opposite fastening points 60, 62 of the fastening geometry 34.

The fastening elements 52, 54 or the fastening points 60, 62 are, for example, positioned relative to one another in such a way that the first brake assembly 14 and the second brake assembly 16, together with the actuator assembly 32 mounted in a first position and a second position, can be arranged mirror-inverted relative to one another with respect to a fictitious mirror plane.

In one exemplary arrangement, the brake callipers 22 and the actuator assemblies 32 of the two brake assemblies can be positioned with mirror symmetry relative to a vertical mirror plane E (see FIG. 1) extending along the central longitudinal axis of the vehicle.

In this way, identical brake assemblies 14, 16 can be formed for a right wheel and a left wheel.

This can be seen in particular in FIG. 6, which shows two brake assemblies 14, 16 with actuator assemblies 32 mounted correspondingly in different angular positions, such that the two brake assemblies 14, 16 can be arranged at opposite ends of the vehicle axle 12 and are mirror-symmetrical with respect to the mirror plane E.

1. A vehicle brake system having a vehicle axle and a first and second brake assembly for a respective electromechanical vehicle brake, wherein the brake assemblies each comprise:
a brake calliper in which a space is provided for receiving a brake rotor,
a linearly guided brake piston that can be moved between a first, extended position and a second, retracted position in order to apply a brake pad to the brake rotor, and
an actuator assembly that can be fastened to the associated brake calliper,
wherein the brake callipers, brake pistons and actuator assemblies are each identical in their respective construction,
wherein a fastening geometry is provided on the brake callipers for fastening the actuator assembly, which fastening geometry is designed such that the actuator assembly can be mounted on the brake calliper in a first position and a second position relative to said brake calliper, and
the brake assemblies can be arranged on opposite sides of the vehicle axle at the same position relative to the brake rotor provided there, wherein the first brake assembly has an actuator assembly fastened to the brake calliper in the first position and the second brake assembly has an actuator assembly fastened to the brake calliper in the second position, and the brake callipers and the actuator assemblies can be positioned with mirror symmetry relative to a vertical mirror plane extending along a central longitudinal axis of a vehicle.

2. A brake assembly for an electromechanical vehicle brake of a vehicle brake system, comprising:
a brake calliper designed as a floating calliper having two guide pins forming a linear bearing, in which a brake calliper space is provided for receiving a brake rotor,
a linearly guided brake piston that can be moved between a first, extended position and a second, retracted position in order to apply the brake pad to the brake rotor, and
an actuator assembly that can be fastened to the brake calliper,
wherein a fastening geometry is provided on the brake calliper for fastening the actuator assembly, which fastening geometry is designed such that the actuator assembly can be mounted on the brake calliper in a first position and a second position relative to said brake calliper, such that the actuator assembly, viewed in a direction of the guide pins, can be mounted relative to a connecting line of the centres of the two guide pins in angular positions that are equal in magnitude but opposite in direction.

3. The brake assembly according to claim 2, wherein the fastening geometry comprises first and second fastening elements, which, in relation to the connecting line of the centres of the two guide pins are in angular positions that are equal in magnitude but opposite in direction.

4. The brake assembly according to claim 3, wherein the first and second fastening elements each have a pair of fastening points, wherein the fastening points lie on a common arc of a circle around a central axis of the brake piston.

5. The brake assembly according to claim 4, wherein the fastening geometry comprises at least four fastening points, which, viewed in the direction of the guide pins, lie diametrically to a central axis of the brake piston.

6. The brake assembly according to claim 2, wherein the brake calliper is designed to be plane-symmetrical with respect to a plane of symmetry, which, on one side, extends in the direction of the guide pins and, on the other side, viewed in the direction of the guide pins, extends perpendicularly relative to the connecting line of the centres of the two guide pins and also along the guide pins.

7. The brake assembly according to claim 2, wherein the fastening elements are positioned relative to one another in such a way that the brake assembly, viewed in the direction of the guide pins, together with the actuator assembly mounted in a first position and a second position, can be arranged mirror-inverted relative to one another with respect to a fictitious mirror plane, in order to form identical brake assemblies for a left wheel and a right wheel.

8. The brake assembly according to claim 2, wherein the brake assembly has an electric motor, which is coupled to the brake piston via a gear unit, a drive shaft and a spindle connected to the latter.

9. The brake assembly according to claim 2, wherein the actuator group has an axially extending central plane of symmetry and halves mirrored thereon.

10. The brake assembly according to claim 2, wherein the actuator assembly has a housing, on which exactly two fastening points are provided for fastening the actuator assembly to the fastening geometry of the brake calliper.

11. The brake assembly according to claim 10, wherein a printed circuit board and/or a gear unit and/or an electric motor for moving the brake piston are accommodated in the housing (36).

12. The brake assembly according to claim 10, wherein a plug connector is arranged on the housing, wherein a plane of symmetry (S_{A}) of the actuator assembly extends through the centre of the plug connector.

13. The brake assembly according to claim 2, wherein the brake assembly defines a service brake.

14. The brake assembly according to claim 5, wherein the brake calliper is designed to be plane-symmetrical with respect to a plane of symmetry, which, on one side, extends in the direction of the guide pins and, on the other side, viewed in the direction of the guide pins, extends perpendicularly relative to the connecting line of the centres of the two guide pins and also along the guide pins.

15. The brake assembly according to claim 5, wherein the fastening elements are positioned relative to one another in such a way that the brake assembly, viewed in the direction of the guide pins, together with the actuator assembly mounted in a first position and a second position, can be arranged mirror-inverted relative to one another with respect to a fictitious mirror plane, in order to form identical brake assemblies for a left wheel and a right wheel.

16. The brake assembly according to claim 5, wherein the brake assembly has an electric motor, which is coupled to the brake piston via a gear unit, a drive shaft and a spindle connected to the latter.

17. The brake assembly according to claim 5, wherein the actuator assembly has a housing, on which exactly two fastening points are provided for fastening the actuator assembly to the fastening geometry of the brake calliper.

18. The brake assembly according to claim 11, wherein a plug connector is arranged on the housing, wherein a plane of symmetry (S_{A}) of the actuator assembly extends through the centre of the plug connector.
